(19) United States
(12) Patent Application Publication
(10) Pub. No.: US 2005/0174524 A1
(43) Pub. Date: Aug. 11, 2005

(54) Liquid crystal display and manufacturing method for the same

(76) Inventors: Jintae Yuh, Gyeonggi-do (KR); Byungseong Bae, Gyeonggi-do (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(21) Appl. No.: 10/512,291

(22) PCT Filed: Apr. 25, 2003
(86) PCT No.: PCT/KR03/00838

(30) Foreign Application Priority Data
Apr. 26, 2002 (KR) 10-2002-22878

(51) Int. Cl. G02F 1/1333

(52) U.S. Cl. 349/158

(57) ABSTRACT

The present invention is related in upper glass, liquid crystal display panel, liquid crystal projector and method for liquid crystal display panel, more specifically, upper glass which is entering light is improved a ratio for aperture using semiconductor etching process. According to the present invention comprises transparent substrate which is transparent light; first thin film which is opposite opaque area on lower substrate make said transparent substrate; second thin film which is making around said first thin film on transparent substrate and thick film is equal density for said second thin layer and make on the said first thin film and said second thin film.

### TECHNICAL FIELD

The present invention relates to an upper substrate, liquid crystal display panel, liquid crystal projector, and manufacturing method for the same, and more specifically, to an upper substrate, liquid crystal display panel, liquid crystal projector, and manufacturing method for the same for increasing an aperture ratio by directly forming a lens on the upper substrate on which light of the liquid crystal display panel is incident, through the application of a semiconductor etching process without a process of attaching another micro lens array.

### BACKGROUND ART

An aperture ratio of a display element such as a liquid crystal display panel is a very important factor to determine performance, and shows degrees of light that is transmitted in the liquid crystal display panel. Since a display element having a high aperture ratio has a wider area for passing the light, the display element can be more brightly displayed than a display element having a low aperture ratio. Thus, when using display elements having the same size and resolution, the display elements having a high aperture ratio can drive a lamp with lower power consumption than the other display element having a low aperture ratio, thereby implementing desired brightness.

In addition, when displaying a bright color, a more similar color to an actual color can be displayed due to excellent brightness, thereby increasing elegant images.

The liquid crystal display panel composed of many pixels locates a light cut-off unit between the pixels or a place where a thin film transistor is located, thus it increases contrast and prevents a leakage current from being generated in a channel unit of the thin film transistor. That is, the liquid crystal display panel prevents the leakage current from being generated in a thin film transistor channel owing to heat energy or light energy itself generated by the incident light. However, the wider an area of the light cut-off unit gets, the smaller a corresponding aperture ratio gets, causing display itself to darken.

To solve these problems, a method of gathering light into an aperture with micro lenses has been suggested, by attaching a micro lens array to the liquid crystal display panel in order to increase optical transmissivity.

FIG. 1 is a plane figure relating to a liquid crystal display panel where micro lenses are formed, according to prior art. Referring to FIG. 1, the process will be described as follows.

An Micro Lens Array(MLA) is formed on an area corresponding to an entire display screen. The micro lens array forms each micro lens(1) every upper part of pixels(3) to which light is transmitted, and locates light cut-off areas(2) such as a wiring unit and a black matrix between the micro lens(1).

FIG. 2 is a sectional view relating to a liquid crystal display panel by FIG. 1. Referring to FIG. 2, the process will be described as follows.

Micro lenses(1) used in a micro lens array refract light transmitted to light cut-off units(2) with pixels(3) by using positive convex lenses, thereby improving brightness. However, the micro lenses(1) are seen round shapes or nearly round shapes on a 2-dimensional plane. Thus, like shown in FIG. 1, spaces that do not cover the lenses are formed between the micro lenses(1), and the transmitted light is not refracted in these spaces. As a result, there is a limit to improve screen luminance.

There can be two methods of manufacturing the liquid crystal display panel to which the micro lens array is attached.

First, an opposite substrate is completed by making a glass surface of the opposite substrate into an embossing surface with the use of a semiconductor photoetching process, and covering and polishing cover glass after coating the embossing surface with a refractive index of glass and other resin and smoothing the embossing surface. The opposite substrate has about tens of micrometers in thickness by the above polishing process.

Second, a molding method is used as follows. A first resin is hardened with the use of UV rays by coating the first resin on a glass substrate and pressurizing a location where micro lenses are formed with a molder. Then, the opposite substrate is completed by covering and polishing the cover glass after coating a second resin having a different refractive index from that of the first resin and hardening the second resin with the use of the UV rays.

A structure of the liquid crystal display panel in the first case is made from the opposite substrate-resin-cover glass-transparent electrode-alignment layer-liquid crystal. A structure in the second case is made from the opposite substrate-resin-resin-cover glass-transparent electrode-alignment layer-liquid crystal.

According to the above manufacturing method, a manufacturing cost can be expensive because of a complicated manufacturing process. Furthermore, since both methods use at least one resin, it is possible to change its properties by light incident from a light source.

The hardening process is required because the resin is used, and the liquid crystal display can be transformed during the manufacturing process, since the resin itself has physically weak hardness.

In addition, since the process is performed from the opposite substrate-resin-cover glass in order, a sawing process only with a high cost in a cutting process can be usable.

In a prior micro lens manufacturing process, the cover glass should be attached in order to adjust the focal distance of the lenses and polished in regular thickness, thereby requiring a complicated process.

As a result, problems of the process and the manufacturing cost were serious due to such prior structure and the process.

### DISCLOSURE OF INVENTION

It is an object of the present invention to provide the upper substrate, the liquid crystal display panel, the liquid crystal projector and method for manufacturing liquid crystal display panel.

The present invention makes aperture ratio 100% achieved and efficiency in light usage is improved, and forms lens on at least part of opposite substrate corresponding to wiring unit which cuts off light and then change path of light which is incident to wiring unit.

To achieve the above object, in upper substrate for a liquid crystal display panel in accordance with the present invention,
an upper substrate of a liquid crystal display panel, comprising: a transparent substrate through which light passes;
a first thin film, said film installed in a location corresponding to a light cut-off area of a lower substrate of the liquid crystal display panel on top of the transparent substrate, and having a concave shape in the middle;
a second thin film, said film installed on the transparent substrate and around the first thin film; and a thick film, said film having same density as the second thin film, and said film installed on the first thin film and the second thin film.

Said thick film is composed of many thin film layers.

In addition, to solve the above object, in a liquid crystal display panel in accordance with the present invention,
a lower substrate, comprising a light transmitting area and a light cut-off area composed of a black matrix, and a wiring to which a signal is applied, an upper substrate which is opposite to the lower substrate and combined at regular cell gaps, and a liquid crystal filled between the lower substrate and the upper substrate,
wherein the upper substrate comprising: a transparent substrate through which light passes;
a first thin film, said film installed in a location corresponding to the light cut-off area of the lower substrate on the transparent substrate, and said film having a concave shape in the middle;
a second thin film, said installed around the first thin film on the transparent substrate;
and a thick film, said having the same density as the second thin film, and said film installed on the first thin film and the second thin film.

In addition, to achieve the above object, in a liquid crystal projector to display for using liquid crystal display panel in accordance with the present invention, In a liquid crystal projector for displaying by use of a liquid crystal display panel, the liquid crystal display panel comprising:
a lower substrate comprising, a light transmitting area and a light cut-off area composed of a black matrix, and a wring to which a signal is applied;
an upper substrate, said substrate being opposite to the lower substrate, and combined at regular cell gaps; and a liquid crystal filled between the lower substrate and the upper substrate;
wherein the upper substrate comprising:
a transparent substrate through which light passes; a first thin film, said film installed in a location corresponding to the light cut-off area of the lower substrate on the transparent substrate, and having a concave shape in middle; a second thin film, said film installed around the first thin film on the transparent substrate; and a thick film, said film having same density as the second thin film, and installed on the first thin film and the second thin film.

In addition, to achieve the above object, in manufacturing method for a upper substrate liquid crystal display panel in accordance with the present invention comprising;
a first step of, forming a first thin film on a transparent substrate, patterning the first thin film to have regular intervals, forming a second thin film having a bigger refractive index than that of the first thin film between the regular intervals, and smoothing an upper part thereof;
a second step of, coating upper parts of the first thin film and the second thin film with a photoregister, exposing the photoregister by using a photo mask, and patterning a middle part of the photoregister located on the second thin film in concave shape;
a third step of, etching the first thin film and the second thin film where the photoregister is patterned, and etching the second thin film in the same shape as the photoregister; and
a fourth step of, forming a thick film by coating the upper parts of the etched second thin film and the first thin film with same material as the second thin film, and smoothing an upper part of the thick film.

In addition, to achieve the above object, in manufacturing method for a liquid crystal display panel in accordance with the present invention comprising;
a first step of, forming a first thin film on a transparent substrate, patterning the first thin film to have regular intervals, forming a second thin film having a bigger refractive index than that of the first thin film between the regular intervals, and smoothing an upper part thereof;
a second step of, coating upper parts of the first thin film and the second thin film with a photoregister, exposing the photoregister with the use of a photo mask, and patterning a middle part of the photoregister located on the second thin film in concave shape;
a third step of, etching the first thin film and the second thin film where the photoregister is patterned, and etching the second thin film in same shape as the photoregister;
a fourth step of, forming a thick film by coating the upper parts of the etched second thin film and the first thin film with same material as the second thin film, and smoothing an upper part of the thick film; and
a fifth step of, installing a transparent electrode and an alignment layer on the thick film;
wherein the manufactured upper substrate is combined with a lower substrate, said substrate having a wiring for changing an electric field at regular cell gaps;
and, wherein a liquid crystal is injected between the upper substrate and the lower substrate.

### BRIEF DESCRIPTION OF DRAWINGS

FIG. 1 is a plane figure relating to a liquid crystal display panel where micro lenses are formed, according to prior art.

FIG. 2 is a sectional view relating to a liquid crystal display panel by FIG. 1.

FIG. 3a through FIG. 3f are diagrams illustrating a manufacturing process of an upper substrate used in a liquid crystal display panel in accordance with the present invention.

FIG. 4a through FIG. 4d are diagrams illustrating one embodiment of a method for manufacturing an upper substrate of a liquid crystal display panel in accordance with the present invention.

FIG. 5 is a structure chart illustrating a structure of one embodiment of a liquid crystal display panel having improved transmissivity in accordance with the present invention.

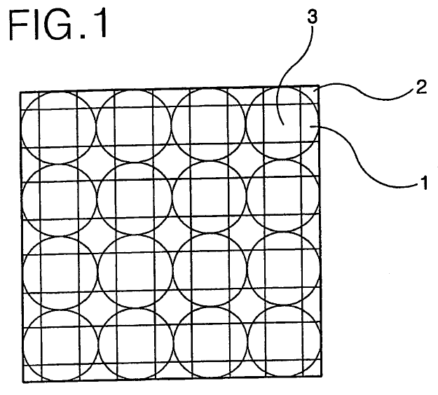

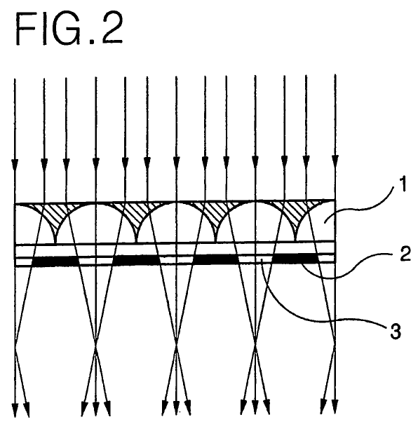

### DESCRIPTION OF REFERENCE NUMERALS IN THE DRAWINGS

10: upper substrate 11: n₁ thin film

13: transparent electrode 14: alignment layer

17: thick film 20: liquid crystal layer

30: lower substrate 31: alignment layer

32: transparent electrode 33: light cut-off area

### BEST MODE FOR CARRYING OUT THE INVENTION

The present invention will now be described more fully hereinafter with reference to the accompanying drawings, in which preferred embodiments of the invention are shown.

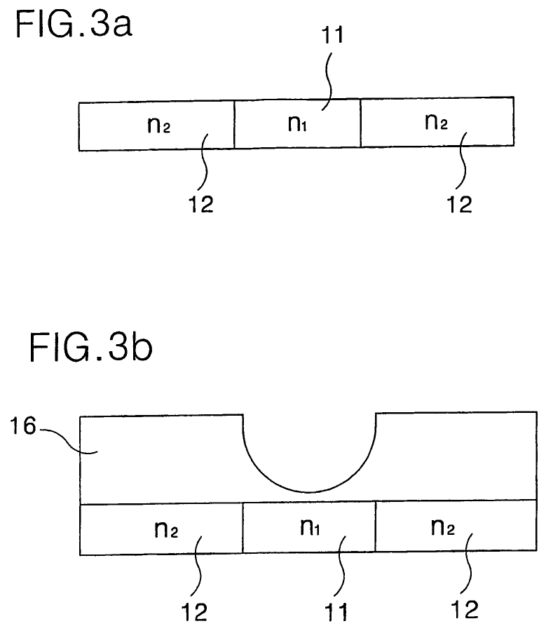

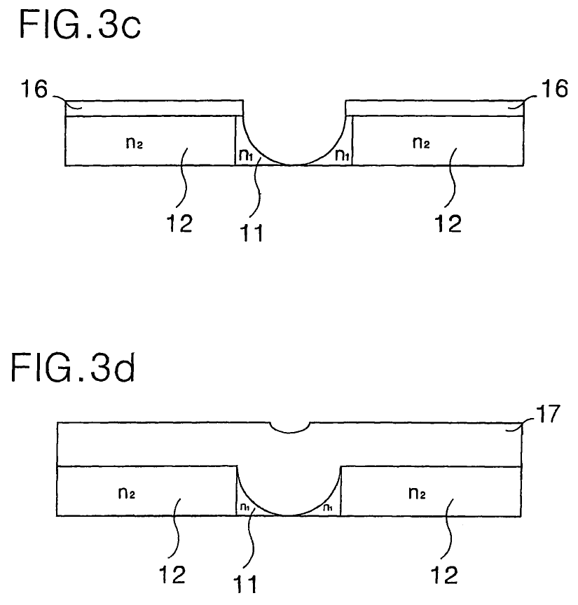

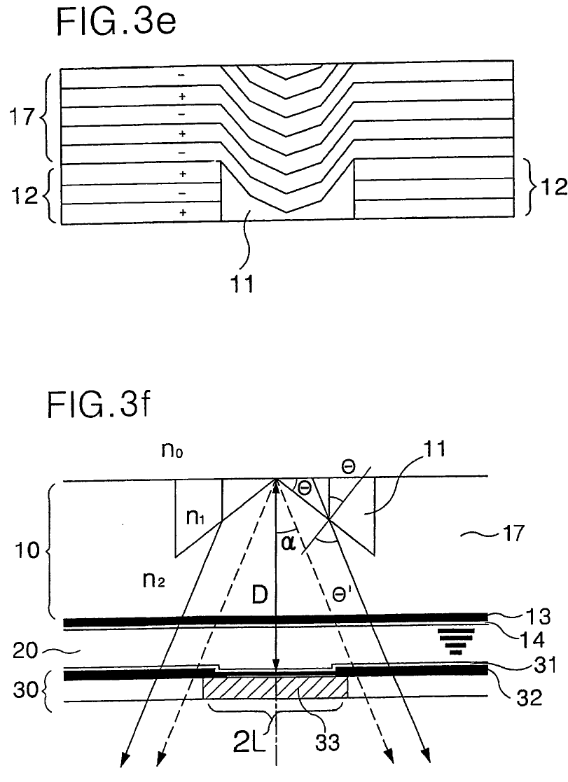

FIG. 3a through FIG. 3f are diagrams illustrating a manufacturing process of an upper substrate used in a liquid crystal display panel in accordance with the present invention. Referring to FIG. 3a through FIG. 3f, the process will be described as follows.

n₂ thin films(12) having certain intervals are formed on many transparent substrates by being deposited and patterned on the transparent substrates. Then, an n₁ thin film(11) is formed between the n₂ thin films(12). At this time, the n₂ thin films(12) can be formed in lamination shape of thin films whose stress is crossed in + and − directions. A location where the n₁ thin film(11) is formed corresponds to a part where a light cut-off area of a lower substrate in the liquid crystal display panel is located (FIG. 3a).

A photoregister(16) is deposited on the n₂ thin films(12) and the n₁ thin film(11) and is developed to form a groove where the photoregister(16) gets thicker, as the photoregister(16) on the n₁ thin film(11) goes to a periphery from a part located in the middle of the n₁ thin film(11), with a photo mask(FIG. 3b). The size of the groove should not exceed horizontal length of the n₁ thin film(11), to prevent the photoregister(16) located on the n₂ thin films(12) from being etched. When the certain-shaped groove is formed in the photoregister(16), make the groove shape formed in the photoregister(16) on the n₁ thin film(11) by etching the groove. In this case, an anisotropic etching should be performed. The anisotropic etching has a bigger etching speed in length direction than an etching speed in horizontal direction, thereby implementing directional dependency on the etching speed. The groove formed on the n₁ thin film(11) by this anisotropic etching has a deep center, and makes the n₁ thin film(11) thicker as going toward the periphery(FIG. 3c).

After completing the above etching process, deposit a thick film(17) having certain thickness by removing the remaining photoregister(16)(FIG. 3d).

The thick film(17) is formed by using materials composed of n₂ thin films and materials having the same refractive index values. With a CVD(Chemical Vapor Deposition) method, the thick film(17) configures layers composed of the n₂ thin films. In case of the n₂ thin films of the thick film(17), each layer is deposited to crossly have opposite stress properties. The layers have tensile and compressive stress properties.

The reason why tensile stress is crossed with compressive stress is as follows. When the thick film(17) having single stress is deposited, a transparent substrate gets bent. By crossly transforming stress of each layer laminated on the thick film(17), the forces between the layers can be reciprocally buffered, thereby preventing the transparent substrate from being bent by the thick film(17).

Depositing multi-layer thin films as crossing stress each other can be accomplished by controlling deposition conditions such as gas density and temperature at the time when the thin films are generated. And, smooth an upper part of the thick film(17). Thick film is not stressed by transparent substrate.(FIG. 3e).

Then, deposit a transparent electrode(13) on the thick film(17), and complete an upper substrate(10) of the liquid crystal display panel by depositing an alignment layer(14) on the transparent electrode(13).

Combine the completed upper substrate(10) with a lower substrate(30) at regular cell gaps, and form a liquid crystal layer(20) between the upper substrate(10) and the lower substrate(30) by injecting a liquid crystal. Then, the liquid crystal display panel is completed(FIG. 3f).

The lower substrate(30) comprises: a thin film transistor formed on a transparent substrate; a wiring unit transmitting a signal for changing an electric field given to a liquid crystal to the thin film transistor; a black matrix(33) cutting off light from being irradiated to the wiring unit; a transparent electrode(32) giving the electric field to a liquid crystal layer by being opposite to a transparent electrode of an upper substrate; and an alignment layer(31) formed on the transparent electrode and maintaining a certain arrangement in the liquid crystal. A light cut-off area cuts off the light by forming the black matrix(33). A light transmitting area is the other area except the light cut-off area.

Since a retractive index of materials forming the thick film(17) is the same as that of the liquid crystal or similar to the liquid crystal, a path of the light is not refracted on a boundary between the thick film(17) and the liquid crystal layer(20). Then n₁ thin film(11) performs a role of a lens refracting the light and determines a refractive index of the n₁ thin film(11), to prevent the light passing through an upper part of the n₁ thin film(11) from being irradiated on the light cut-off area located in a lower part of the n₁ thin film(11) by being refracted on a boundary between the n₁ thin film(11) and the thick film(17). Therefore, the refractive index of the n₁ thin film(11) should be bigger than that of the n₂ thin films(12).

In order to prevent the light refracted on a boundary between the n₁ thin film(11) and the n₂ thin films(12) from being irradiated on the light cut-off area such as the black matrix or the wiring unit of the lower substrate, the light cut-off area should be separated from the n₁ thin film(11) at a certain distance. The distance is determined by differences between the refractive indexes of the n₁ and the n₂ thin films, and is controlled with thickness of the deposited thick film(17).

Supposing an angle created between the light incident on the liquid crystal display panel and a boundary of the n₁ thin film and the thick film(17) is Θ, a refractive angle refracted on the boundary is Θ′, and refractive indexes between the n₁ thin film and the n₂ thin films are n₁ and n₂, respectively, and defining a distance up to the light cut-off film from the middle of the n₁ thin film is D and width of the light cut-off film is 2L, then defining a minimum angle irradiated on the light transmitting area by being refracted on the boundary between the n₁ thin film and the n₂ thin films is α, without the light incident from the middle of the n₁ thin film being bumped against the light cut-off area, the following formula is obtained.

$${n}_{1} sin θ = {n}_{2} sin {θ}^{′} \\ {θ}^{′} = θ + α \\ tan α \geq \frac{L}{D} \qquad [ Formula 1 ]$$

Thus, according to the formula 1, thickness of the thick film is determined by D length, thickness of the liquid crystal layer and the refractive index of the thick film, and the refractive index of the n₁ thin film. It is desirable that the refractive index of the thick film is within a range of 1.4 to 1.6.

Generally, forming the thick film takes much time and large-sized equipments. However, the thick film can be simply deposited by using a method of generating ultra corpuscle through an aerosol process with the use of high frequency inductive heating source, sending the ultra corpuscle, and accumulating the ultra corpuscle with a vacuum chamber for accumulating the ultra corpuscle.

Corpuscle aerosols are generated by heating and evaporating metal materials through a high frequency inductive heating process, among inactive gases pressurized by water pressure in a chamber for generating corpuscle. The corpuscle have tens of nanometers in size, approximately. And, the corpuscle aerosols are sent to the vacuum chamber and are sprayed as sonic aerosols through minute nozzles having tens of micrometers in diameter. The corpuscle are accelerated at about 900 m every second. At this moment, kinetic energy of the particles is converted into heat energy, causing a local sintering phenomenon. As a result, the thick film is formed at high speed.

Also, it is possible to shape various patterns or inclined function structures under control of a 3-dimensional precise vacuum stage or by mixing and switching the sent particles, as well as remove a portion or the entire lamination film with the use of laser.

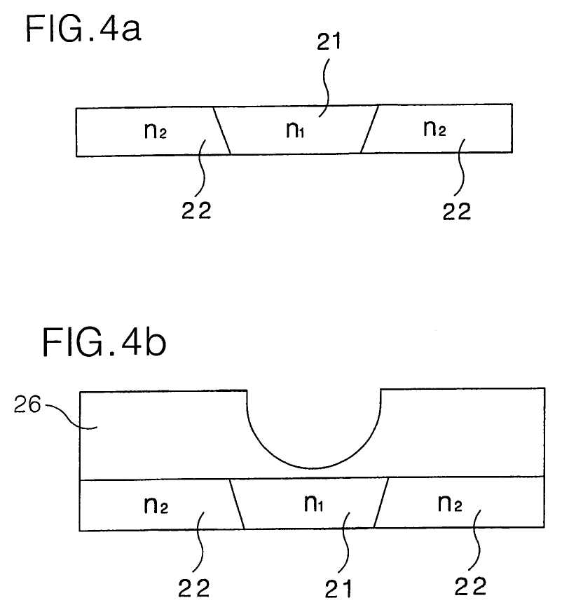

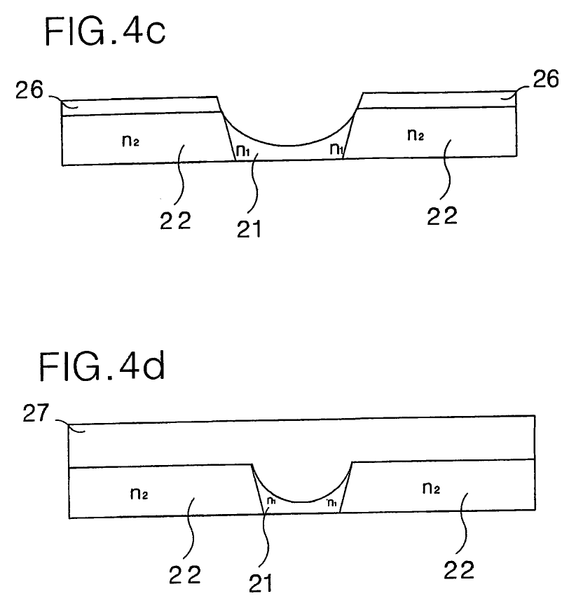

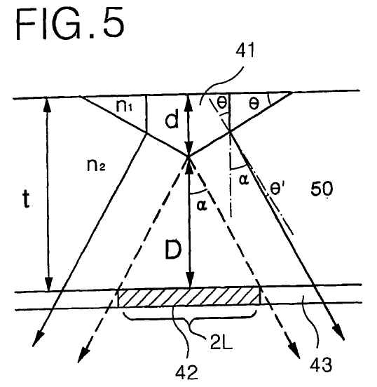

FIG. 4a through FIG. 4d are diagrams illustrating one embodiment of a method for manufacturing an upper substrate of a liquid crystal display panel in accordance with the present invention. Referring to FIG. 4a through FIG. 4d, the process will be described as follows.

Many n₂ thin films(22) having certain intervals are formed on a transparent substrate by being deposited and patterned on the transparent substrate. After that, an n₁ thin film(21) is formed between the n₂ thin films(22). A boundary between the n₂ thin films(22) and the n₁ thin film(21) is inclined with a predetermined angle, thereby making the n₁ thin film in a reverse trapezoid shape (FIG. 4a).

Then, a photoregister(26) is deposited on the n₂ thin films(22) and the n₁ thin film(21) and is developed by forming a groove where the photoregister(26) gets thicker, as the photoregister(26) on the n₁ thin film(21) goes to a periphery from a part located in the middle of the n₁ thin film(21), with the use of photo mask(FIG. 4b). The size of the groove should not exceed horizontal length of the n₁ thin film(21), to prevent the photoregister(26) located on the n₂ thin films(22) from being etched.

When the certain-shaped groove is formed in the photoregister(26), make the groove shape formed in the photoregister(26) on the n₁ thin film(21) by etching the groove. In this case, an anisotropic etching should be performed. The groove formed on the n₁ thin film(21) by this anisotropic etching has a deep center, and makes the n₁ thin film(21) thicker as going toward the periphery(FIG. 4c).

After completing the above etching process, deposit and smooth a thick film(27) having certain thickness by removing the remaining photoregister(26)(FIG. 4d).

Then, complete the upper substrate of the liquid crystal display panel in the same way as described in FIG. 3, and complete the liquid crystal display panel by injecting a liquid crystal after the upper substrate coheres with the lower substrate.

FIG. 5 is a structure chart illustrating a structure of one embodiment of a liquid crystal display panel having improved transmissivity in accordance with the present invention. Referring to FIG. 5, the process will be described as follows.

When a refractive index(n₁) of a lens material is smaller than an average refractive index(n₂) of a liquid crystal(50), a lens(41) has a conic shape whose middle part is convex like shown in the diagram. The cone-shaped lens(41) is formed on an upper substrate opposite to a lower substrate in which a light cut-off film(42) and a pixel(43) are installed.

Also, by locating the light cut-off film(42) on the lower substrate opposite to a location where the lens(41) of the upper substrate is formed, it is possible to irradiate light to the pixel by refracting the light irradiated to the light cut-off film(42)

Defining that width of the light cut-off film(42) is 2L, an incident angle is Θ and a refraction angle is Θ′, a distance to the lens(41) from the light cut-off film(42) is D, height of the lens(41) is d, a distance to an opposite substrate from the light cut-off film(42) is t, and a minimal angle at which the light incident from the middle of the lens(41) passes by changing a path in order not to be bumped into the light cut-off film(42) is α, the following formula 2 can be obtained.

$${n}_{1} sin θ = {n}_{2} sin {θ}^{′} \\ {θ}^{′} = θ + α \\ tan α \geq \frac{L}{D} = \frac{L}{t - d} \qquad [ Formula 2 ]$$

Since an n₁ value is smaller than an n₂ value, the size of the refraction angle Θ′ gets smaller than the incident angle Θ, thereby refracting the incident light to a pixel area(43). Therefore, if the liquid crystal display panel satisfies the formula 2, it is available to improve transmissivity of the liquid crystal display panel having an ideal 100% aperture ratio.

A process for protruding the lens is performed as follows. First, coat the substrate with a lens resin. It is desirable to use a photosensitive resin for the lens resin. However, if not the photosensitive resin, perform a patterning process by using a semiconductor photoregister.

After the patterning, the residual lens resin is formed by corresponding to a wiring unit, the light cut-off film or a TFT channel unit of the lower substrate. Thus, the lens can be directly formed on the substrate without attaching layers of the lens to the substrate after manufacturing the lens layers, thereby simplifying the process and solving lens align problems.

In addition, the residual lens resin should have an incline plane through development or strip process. After obtaining the incline plane, perform a heat treatment process.

Inorganic materials or oxide films can be used as lens materials, and in this case, it is possible to form the lens through a general photoetching semiconductor process.

And, since an orientation of the liquid crystal may be disturbed by the lens protruded on the opposite substrate(upper substrate), it is desirable to coat and smooth a resin having a different refractive index from the lens or an inorganic material, so that the resin or the inorganic material have the same height as the lens.

Also, it is possible to more clearly display an image by manufacturing a liquid crystal projector with the use of the liquid crystal display panel in accordance with the present invention.

### INDUSTRIAL APPLICABILITY

According to an upper substrate, liquid crystal display, liquid crystal projector, and a method for manufacturing the liquid crystal display panel in accordance with the present invention, it is possible to increase an aperture ratio of the liquid crystal display panel with much light through pixels, by refracting the light irradiated to an area where the light is not transmitted and irradiating the refracted light to areas such as the pixels where the light is transmitted.

Then, misalign phenomenon can be prevented by locating the lens for refracting the light on the upper substrate of the liquid crystal display. Thus, it can increase efficiency of a light source by magnifying light efficiency, thereby reducing heat generated from the light source with the use of the light source having low power consumption. As a result, it prevents deterioration of projector performance as well as defects.

Furthermore, it can increase display quality by reproducing the same color as the actual color with a process of manufacturing display having excellent luminance.

And, it is unnecessary to use a cover glass used to adjust the focal distance of the lens, enabling a simple manufacturing process without another materials. Accordingly, a manufacturing cost can be cheaper with reduced raw materials, as well as the liquid crystal projector can be inexpensive.

This invention may, however, be embodied in different forms and should not be construed as limited to the embodiments set forth herein. Rather, these embodiments are provided so that this disclosure will be thorough and complete, and will fully convey the scope of the invention to those skilled art.

1. An upper substrate of a liquid crystal display panel, comprising: a transparent substrate through which light passes;
a first thin film installed in a location corresponding to a light cut-off area of a lower substrate of the liquid crystal display panel on top of the transparent substrate, and having a concave shape in the middle;
a second thin film installed on the transparent substrate and around the first thin film; and
a thick film having substantially the same density as the second thin film, and said thick film is installed on the first thin film and the second thin film.

2. The upper substrate of claim 1, wherein the thick film is comprised of many thin film layers.

3. The upper substrate of claim 2, wherein many thin films comprising the thick film are installed by crossing stress polarity thereof.

4. The upper substrate of claim 1, wherein the thick film removes stress from the upper substrate.

5. The upper substrate of claim 1, wherein the first thin film has a predetermined inclination on a boundary with the second thin film.

6. A liquid crystal display panel comprising:
a lower substrate, comprising a light transmitting area and a light cut-off area composed of a black matrix, and a wiring to which a signal is applied,
an upper substrate which is opposite to the lower substrate and combined at regular cell gaps, and
a liquid crystal material between the lower substrate and the upper substrate, wherein the upper substrate comprises:
a transparent substrate through which light passes;
a first thin film installed in a location corresponding to the light cut-off area of the lower substrate on the transparent substrate, and said first thin film having a concave shape in the middle;
a second thin film around the first thin film on the transparent substrate; and
a thick film having substantially the same density as the second thin film, and said thick film installed on the first thin film and the second thin film.

7. The liquid crystal display panel of claim 6, wherein the thick film is comprised of many thin film layers.

8. The liquid crystal display panel of claim 7, wherein thin films of the thick film are installed by crossing stress polarity thereof.

9. The liquid crystal display panel of claim 6, wherein the first thin film has a predetermined inclination on a boundary with the second thin film.

10. The liquid crystal display panel of claim 6, wherein refractive indexes of the thick film and the liquid crystal are substantially the same.

11. A liquid crystal projector for displaying by use of a liquid crystal display panel, the liquid crystal display panel comprising:
a lower substrate comprising a light transmitting area and a light cut-off area composed of a black matrix, and a wiring to which a signal is applied;
an upper substrate disposed opposite to the lower substrate, and combined at regular cell gaps; and
a liquid crystal material between the lower substrate and the upper substrate; wherein the upper substrate comprises:
a transparent substrate through which light passes;
a first thin film installed in a location corresponding to the light cut-off area of the lower substrate on the transparent substrate, and having a concave shape in middle;
a second thin film installed around the first thin film on the transparent substrate; and
a thick film having substantially the same density as the second thin film, and installed on the first thin film and the second thin film.

12. The upper substrate of claim 11, wherein the thick film is composed of many thin film layers.

13. The liquid crystal projector of claim 12, wherein thin films of the thick film are installed by crossing stress polarity thereof.

14. The liquid crystal projector of claim 11, wherein the first thin film has a predetermined inclination on a boundary with the second thin film.

15. A method of manufacturing an upper substrate, comprising:
a first step of forming a first thin film on a transparent substrate, patterning the first thin film to have regular intervals, forming a second thin film having a larger refractive index than that of the first thin film between the regular intervals, and smoothing an upper part thereof;
a second step of coating upper parts of the first thin film and the second thin film with a photoresist, exposing the photoresist by using a photo mask, and patterning a middle part of the photoresist located on the second thin film in concave shape;
a third step of etching the first thin film and the second thin film where the photoresist is patterned, and etching the second thin film in substantially the same shape as the photoresist; and
a fourth step of forming a thick film by coating the upper parts of the etched second thin film and the first thin film with substantially the same material as the second thin film, and smoothing an upper part of the thick film.

16. The method of claim 15, wherein a refractive index of the first thin film is smaller than that of the second thin film.

17. The method of claim 15, wherein the thickness of the thick film is determined by
$$tan α \geq \frac{L}{D}$$
and a refractive index of both the thick film and the first thin film.

18. The method of claim 15, wherein the thick film is comprised of multi layered thin films.

19. The method of claim 18, wherein stress directions are alternately applied to the thick film.

20. A method for manufacturing a liquid crystal display panel, said method comprising:
manufacturing an upper substrate of the liquid crystal display panel, wherein said method comprising:
a first step of forming a first thin film on a transparent substrate, patterning the first thin film to have regular intervals, forming a second thin film having a larger refractive index than that of the first thin film between the regular intervals, and smoothing an upper part thereof;
a second step of coating upper parts of the first thin film and the second thin film with a photoresist, exposing the photoresist with the use of a photo mask, and patterning a middle part of the photoresist located on the second thin film in concave shape;
a third step of etching the first thin film and the second thin film where the photoresist is patterned, and etching the second thin film in same shape as the photoresist;
a fourth step of forming a thick film by coating the upper parts of the etched second thin film and the first thin film with same material as the second thin film, and smoothing an upper part of the thick film; and
a fifth step of installing a transparent electrode and an alignment layer on the thick film;
wherein the upper substrate is combined with a lower substrate, said substrate having a wiring for changing an electric field at regular cell gaps;
and, wherein a liquid crystal material is disposed between the upper substrate and the lower substrate.

21. The method of claim 20, wherein a refractive index of the thick film is between approximately 1.4 to 1.6.

22. A liquid crystal display element having improved permeability, comprising:
a lower substrate laminated by many TFT electrodes a pixel electrode and an alignment layer;
an opposite substrate disposed opposite to the lower substrate and laminated by an opposite electrode a projection-type lens and an alignment layer, and wherein the projection-type lens is located opposite to a light cut-off film of the lower substrate; and
a liquid crystal material between the lower substrate and the opposite substrate.
